(19) United States
(12) Patent Application Publication
(10) Pub. No.: US 2004/0260632 A1
(43) Pub. Date: Dec. 23, 2004

(54) Prepaid commodity purchase system

(76) Inventor: Thomas Joseph Wanasek, Plano, TX (US)

Correspondence Address: THOMAS J. WANASEK, 9813 ST. ANNE'S DR., PLANO, TX, 75025, US

(21) Appl. No.: 10/860,569

(22) Filed: Jun. 3, 2004

Related U.S. Application Data
(60) Provisional application No. 60/479,728, filed on Jun. 19, 2003.

(51) Int. Cl. G06F 17/60

(52) U.S. Cl. 705/30

(57) ABSTRACT

A prepaid commodity purchase system comprises purchase of a predetermined commodity, such as unleaded gasoline for example, by a purchaser, and subsequent delivery of the commodity in kind to the purchaser at designated outlets. The purchaser transfers funds to a commodities marketer via an internet website wherein marketers offer their products in predetermined quantities at predetermined prices in a competitive market environment. The marketer or its agent establishes a commodity purchase account on behalf of the purchaser. The purchaser subsequently receives the purchased commodity in kind at designated outlets. The receipt of the commodity is debited against the purchaser's prepaid commodity purchase account. This invention allows consumers to purchase large quantities of product at predetermined prices for future delivery.

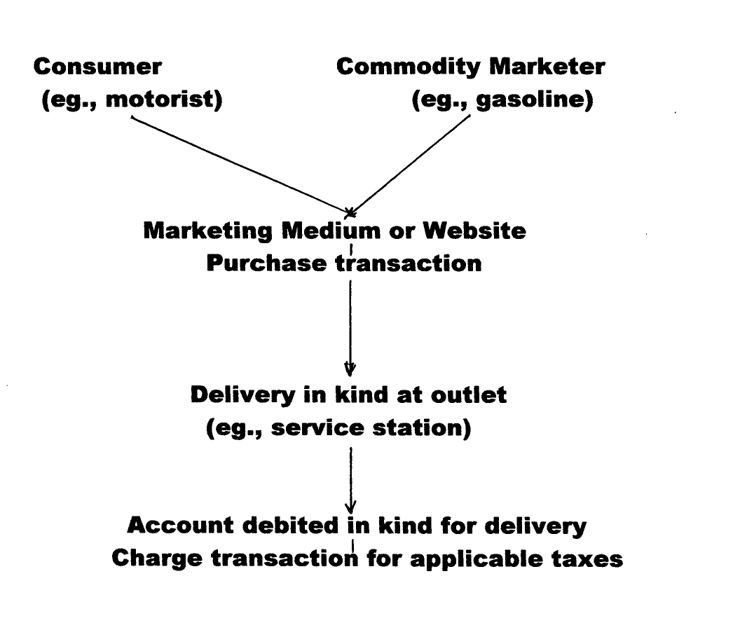

This application claims the benefit of provisional patent application No. 60/479,728 filed on Jun. 19, 2003, entitled “Prepaid Commodity Purchase System”.

### TECHNICAL FIELD

This invention relates to a commodity purchase system involving prepayment for and subsequent in-kind delivery of a specific commodity, and more particularly to a system which permits consumers to pre-purchase fuels and other commodities in bulk and to subsequently receive the pre-purchased commodities in kind, for example at fueling stations, and the like.

Currently, consumers may have the ability to pre-pay, or use prepaid type cards to purchase motor fuels, for example at current offered prices. This invention would allow the purchaser to prepay for the purchase, and lock-in an agreed price per unit. The commodity, (gasoline, for example) would be delivered in kind at the pre-purchased price.

### BACGROUND AND SUMMARY OF THE INVENTION

Airlines, shipping companies, and other consumers of large quantities of fuel frequently utilize commodities futures trading to hedge against fluctuations in fuel prices. Also, businesses that use large quantities of fuel in day to day operations typically have fuel storage facilities which allow them to purchase large quantities of fuel when prices are relatively low, and to consume the relatively inexpensive fuel from their storage facilities at times when prices are higher.

Conversely, individual consumers, small business owners, owner-operators of small truck fleets, etc. typically do not purchase fuel in sufficient quantities to justify the perils of commodity futures trading. Unlike businesses that consume large quantities of fuel, individuals, small business owners, and the like, typically do not have fuel storage facilities of sufficient capacity to effectively offset fluctuations in fuel prices. Consumers of small quantities of fuel are therefore forced to pay whatever the current price of fuel may be in order to operate.

The present invention comprises a commodity purchase system which overcomes the foregoing and other difficulties which have long since characterized the prior art. In accordance with the broader aspects of the invention, consumers of small quantities of a particular commodity pre-purchase the commodity in bulk. For example, the owner-operator of an n over-the-road truck may pre-pay/purchase 10,000 gallons of diesel fuel at a point in time when the price of fuel is deemed to be advantageous. The purchase is then credited to an account which is accessible by the purchaser through the use of a fuel access card that is similar to a credit card. Alternatively, the purchaser's fuel access card may include a storage medium, which is updated to reflect the purchase.

An important feature of the invention comprises the fact that the consumer's purchase is stored in the consumer's account or within the consumer's commodity access card in commodity units; for example, in the case of liquid fuels, the purchase is stored in terms of gallons or liters, whereas in the case of gaseous fuels, the purchase is stored in terms of cubic feet or meters, etc. Stated differently, the consumer's purchase comprises the right to subsequently redeem a predetermined number of cubic feet or meters of gaseous fuel, etc.

Any time after the consumer's account has been credited, the consumer may elect to redeem some or all of the purchase in kind. For example, the owner-operator of an over-the-road truck who has purchased 10,000 gallons of diesel fuel goes to a fueling station that dispenses diesel fuel. inserts his fuel access card into a card reader, and thereafter fills the truck fuel tank with fuel. The number of gallons received is debited against the purchaser's commodity purchase account, or is deducted from the quantity stored in the memory of the fuel access card. The process is repeated until the purchaser has received the entirety of the pre-purchased commodity.

Another important feature of the invention comprises the fact that the purchaser's commodity purchase account or access card can be updated and replenished remotely, for example, using the facilities of the internet. Using a credit card, debit card, ATM, or other type of financial card, or utilizing direct funds transfer, the purchaser's commodity purchase account or commodity access card is initially credited in a stated currency amount which is subsequently used to purchase a specific quantity of fuels, gas, etc. As stated above, the purchaser's commodity purchase account or commodity access card is subsequently debited when the purchaser receives the purchased commodity in kind.

### DETAILED DESCRIPTION

The present invention will be readily understood by reference to the following examples:

A consumer owns an auto which requires premium gasoline. The consumer establishes a commodity (fuel) purchase account with a fuels marketer. The consumer monitors the price of premium gasoline by reference to financial periodicals, or by access to a fuel center marketing website whereupon fuel marketers offer for sale various fuel products at specific prices and in predetermined quantities.

When the consumer determines that the offered price for a specific fuel is at an advantageous level, he/she pre-purchases 1000 gallons of premium gasoline, for example, from the marketer he/she selects. The purchase is accomplished using a credit card, debit card, ATM card, or any other type of financial card, or by utilizing direct funds transfer. Upon confirmation of [payment, the fuel marketer credits the consumer's commodity purchase account with 1,000 gallons of premium gasoline.

The consumer is not required to utilize his/her commodity purchase account for the purchase of gasoline at any particular time, unless pre-agreed. Therefore, if the purchase price of premium gasoline should decline, the consumer may elect to defer use of the account balance. The consumer may elect to add new fuel purchases to the account, thus achieving a lower average price for the total quantity of gasoline credited to the account.

If the price of premium gasoline increases, or at any other time, the consumer may elect to draw upon the fuel balance in the account. To do so, the purchaser goes to an outlet operated by the marketer from whom the fuel was purchased, or by agreement, from any fuel marketer, utilizing an access card similar in size, shape, and function, to a credit card, and fills the car fuel tank with premium gasoline. The transaction is completed by debiting the consumers commodity purchase account by the number of gallons that were used to fill the tank.

Or, an independent trucker utilizes one or more over the road trucks which require diesel fuel. The transaction is the same as described in the foregoing example, except that the owner-operator purchases diesel fuel from the marketer. Diesel fuel is received by the owner-operator at stations affiliated with the marketer, or by agreement, with any fuel marketer.

Or, a large package delivery company owns and operates many vehicles. The package delivery company employs many drivers to operate its vehicles. No association exists between a particular driver and vehicle. The package delivery company purchases various quantities of various fuels from a fuel marketer, for example, via an internet fuel-marketing site. Each driver is provided with a fuel purchase card which allows the driver to purchase fuel for the vehicle he/she is operating at a particular time. Whenever the driver utilizes the fuel purchase card to purchase fuel for one of the vehicles owned by the delivery company, the identity of the driver making the purchase can be recorded. The driver is required to provide indicia of the vehicle being fueled. Fuel purchases made by drivers employed by the package delivery company are debited against the commodity purchase account maintained by the package delivery company.

Or, a governmental agency employs police officers, maintenance workers, and other personnel. The agency operates hundreds of vehicles of various types which require various types of fuel. The governmental agency maintains a commodity purchase account with a fuel marketer and periodically purchases various quantities and types of fuels. The employees of the agency purchase fuel for use in vehicles owned by the agency in the same manner as described above.

A credit card company, bank, commodity futures firm or exchange, or any other entity maintains a website which allows fuel marketers, for example, to offer particular fuels in specific quantities, and at specific offered prices for specific periods of time. The same website allows users of the system of the present invention to transfer credit to their respective commodity purchase account and or commodity purchase cards. Thus, users of the system are allowed to purchase commodities (gasoline for example) simultaneously with the transfer of credit to their respective accounts.

As is well known to those skilled in the art, the transfer of petroleum based commodities typically involves the payment of various taxes. In accordance with the present invention the fuel purchase card which allows a user of the system to draw from his/her commodity purchase account, may also serve as a credit card which is used to pay the necessary taxes at the time the fuel is dispensed, thereby allowing for the differential in taxes charged in various localities. The gallonage dispensed would be debited against the commodity in-kind balance in the purchase system account, while a simultaneous charge would be effected for motor fuel taxes due in a separate transaction.

As will be apparent, the present invention is highly advantageous to consumers because it allows commodity consumers to purchase commodities at a time when prices are relatively low. In so doing, commodity purchasers are able to hedge against commodity price spikes thereby facilitating planning, budgeting, and considerable cost savings. The use of the present invention is also advantageous to commodity suppliers. For example, by pre-selling substantial quantities of a given commodity in a single transaction, the marketer builds brand loyalty. Perhaps more importantly, because the commodity supply company has been paid in advance for the commodities, but does not deliver until a later date, the commodity marketer has the use of the funds it received during the time periods between the initial purchase, and the actual delivery of the product. For planning purposes, the marketer would have the opportunity to presell its production for any given period of time at its discretion.

The present invention is also advantageous to credit card issuers such as “VISA” [symbol] . It is contemplated that commodity suppliers will employ such companies to issue commodity access cards for use in conjunction with the present invention. Such card issuers may choose to maintain and sponsor the transaction website to produce fee income.

As will be apparent to those skilled in the art, the present invention has been described herein in conjunction with the sale and subsequent delivery of fuels. However, this invention is not limited to use in conjunction with fuels, but rather can be used in conjunction with the sales of delivery of a wide variety of commodities.

Although preferred embodiments of the inventions have been illustrated in the accompanying drawing and in the foregoing detailed description, it will be understood that the invention is not limited to the embodiments disclosed, but is capable of numerous rearrangements, modifications, and substitutions of parts end elements without departing from the spirit of the invention.

What I claim as my invention is:

1 A method of commodity distribution comprising the steps of:
transferring funds representing the purchase of a predetermined quantity of a predetermined commodity from a purchaser to a commodity marketer;
utilizing the transferred funds to effect the purchase of the predetermined quantity of the predetermined commodity;
establishing a commodity purchase account in the name of the purchaser;
crediting the purchaser's commodity purchase account with the results of the commodity purchase denominated in quantity units;
subsequently delivering at least a part of the commodity purchase in kind from the marketer to the purchaser; and
debiting the purchaser's commodity purchase account in accordance with the quantity of the commodity delivered to the purchaser.

2 The method according to claim 1 wherein the commodity purchase account is maintained for the benefit of the purchaser by the marketer or its agent and is accessible by the purchaser utilizing a commodity access card.

3 The method according to claim 1 further including the step of providing the purchaser with a commodity access card having a built-in-memory, and wherein the purchaser's commodity purchase account is maintained in the memory of the commodity access card.

4 The method according to claim 1 further including the ability for the purchaser to utilize a commodity marketing website whereupon buyers can purchase particular amounts of fuels or commodities at specific offered prices determined by marketers, for future delivery in kind at or by designated outlets.
